(19) United States
(12) Patent Application Publication
(10) Pub. No.: US 2002/0076095 A1
(43) Pub. Date: Jun. 20, 2002

(54) Automatic optical inspection of printed circuit board packages with polarity

(76) Inventors: Sim Ching Tong, Singapore (SG); Rory S. Limqueco, Singapore (SG)

Correspondence Address: Theodore M. Magee, WESTMAN CHAMPLIN & KELLY, Suite 1600 - International Centre, 900 South Second Avenue, Minneapolis, MN, 55402-3319, US

(21) Appl. No.: 09/897,760

(22) Filed: Jun. 29, 2001

Related U.S. Application Data
(60) Provisional application No. 60/257,057, filed on Dec. 20, 2000.

(51) Int. Cl. G06K 9/00

(52) U.S. Cl. 382/145; 382/165

(57) ABSTRACT

An optical inspection system and a method of inspecting a printed circuit board identify a color for a package of a component and identify dark areas and light areas on the package. The identified color is then used to determine which of the dark areas or light areas represent markings. From the identified markings, the orientation of the component is determined.

### CROSS-REFERENCE TO RELATED APPLICATION

This application claims priority from U.S. Provisional Application 60/257,057 filed on Dec. 20, 2000 for inventors Sim Ching Tong and Rory S. Limqueco and entitled Methodology of Automatic Optical Inspection (AOI) of Package with Polarity.

### FIELD OF THE INVENTION

The present invention relates generally to automatic optical inspection, and more particularly but not by limitation to automatic optical inspection of printed circuit boards.

### BACKGROUND OF THE INVENTION

Most modern electronics include at least one printed circuit board. A printed circuit board contains a collection of components that are soldered to the board and are connected by trace lines that allow electrical current to flow between the various components. Typically, reference marks are placed on the printed circuit board to indicate where the various components should be located and how the components should be oriented on the printed circuit board. For example, a marking such as R4 may be placed between two connection points on the printed circuit board to indicate that the leads/terminals of a resistor are to be attached to the connection points. Similarly, a symbol such as C10 can be placed between connection points on the printed circuit board to indicate that the leads/terminals of a capacitor should be attached to the connection points.

For some capacitors, it is important that the proper terminal of the capacitor be attached to the proper connection point. In particular, for tantalum capacitors, the two terminals of the capacitors have different polarities such that one terminal is known as the positive polarity terminal and the other terminal is known as the negative polarity terminal. On the printed circuit board, a small “+” is placed near the connection point that is to accept the positive terminal of the capacitor.

To assist in placing the capacitor in the printed circuit board, capacitor manufacturers denote the positive polarity of their capacitors with a wide bar located on the top of the capacitor package. This wide bar should be close to the plus symbol on the printed circuit board when the capacitor is properly installed in the printed circuit board.

After a printed circuit board has been assembled, its assembly is inspected to ensure that all of the components are in the printed circuit board and that all the components that require a specific orientation are in their proper orientation. The inspection of the printed circuit board can be performed manually or through an automated inspection system. Manual inspection is not preferred since it is susceptible to human error. However, automated inspection is not easy to implement for all printed circuit boards.

In particular, automated inspection systems have difficulty coping with changes in the components used in the printed circuit board. These problems arise because most automated systems check the printed circuit board based on a template of how the components on the printed circuit board should appear. If the packaging for one of the components changes, such as when a different manufacturer's component is used in the printed circuit board, the inspection system will not be able to identify the new component as being inserted properly in the printed circuit board because the new component will not match the template. Some systems have attempted to overcome this problem by keeping a separate template for each possible package for a component. However, the proper template must be switched into the inspection system when the component changes.

In addition, prior art inspection systems are negatively affected by visual noise in the components of the printed circuit board. This visual noise includes markings on the components that are used to identify the components. For example, changes in the size of the bar on a Tantalum capacitor or changes in the markings on a Tantalum capacitor can cause template matching systems to falsely reject a properly placed capacitor.

In light of this, an optical inspection is needed that is able to identify the polarity of components made by different manufacturers without requiring templates to be changed with every change of components used in the printed circuit board.

Embodiments of the present invention provide a solution to this and other problems, and offer other advantages over the prior art.

### SUMMARY OF THE INVENTION

An optical inspection system and a method of inspecting a printed circuit board identify a color for a package of a component and identify dark areas and light areas on the package. The identified color is then used to determine which of the dark areas or light areas represent markings. From the identified markings, the orientation of the component is determined.

Other features and benefits that characterize embodiments of the present invention will be apparent upon reading the following detailed description and review of the associated drawings.

### BRIEF DESCRIPTION OF THE DRAWINGS

FIG. 1 is an isometric view of a disc drive containing a printed circuit board formed through a process in accordance with an embodiment of the present invention.

FIG. 2 is a top view of a printed circuit board showing markings on the printed circuit board and various components attached to the printed circuit board.

FIG. 3 is a top view of a capacitor package from a first manufacturer attached properly to a printed circuit board.

FIG. 4 is a top view of a capacitor from a second manufacturer attached improperly to a printed circuit board.

FIG. 5 is a flow chart of a method of optical inspection in accordance with an embodiment of the present invention.

FIG. 6 is a top view of a capacitor package with a search window.

FIG. 7 is a top view of a capacitor package with a search window showing a binary conversion of the image in the search window.

FIG. 8 is a block diagram of an optical inspection system in accordance with an embodiment of the present invention.

### DETAILED DESCRIPTION OF ILLUSTRATIVE EMBODIMENTS

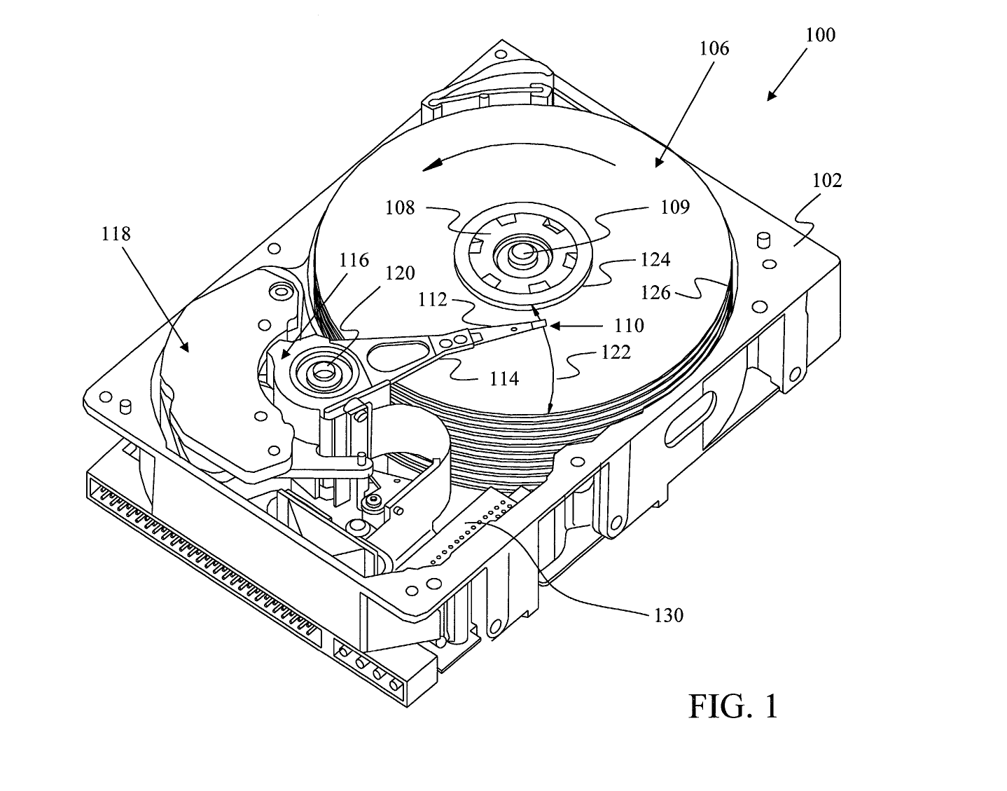

FIG. 1 is an isometric view of a disc drive 100 in which embodiments of the present invention are useful. Disc drive 100 includes a housing with a base 102 and a top cover (not shown). Disc drive 100 further includes a disc pack 106, which is mounted on a spindle motor (not shown) by a disc clamp 108. Disc pack 106 includes a plurality of individual discs, which are mounted for co-rotation about central axis 109. Each disc surface has an associated disc head slider 110 which is mounted to disc drive 100 for communication with the disc surface. In the example shown in FIG. 1, sliders 110 are supported by suspensions 112 which are in turn attached to track accessing arms 114 of an actuator 116. The actuator shown in FIG. 1 is of the type known as a rotary moving coil actuator and includes a voice coil motor (VCM), shown generally at 118. Voice coil motor 118 rotates actuator 116 with its attached heads 110 about a pivot shaft 120 to position heads 110 over a desired data track along an arcuate path 122 between a disc inner diameter 124 and a disc outer diameter 126. Voice coil motor 118 is driven by servo electronics 130 based on signals generated by heads 110 and a host computer (not shown).

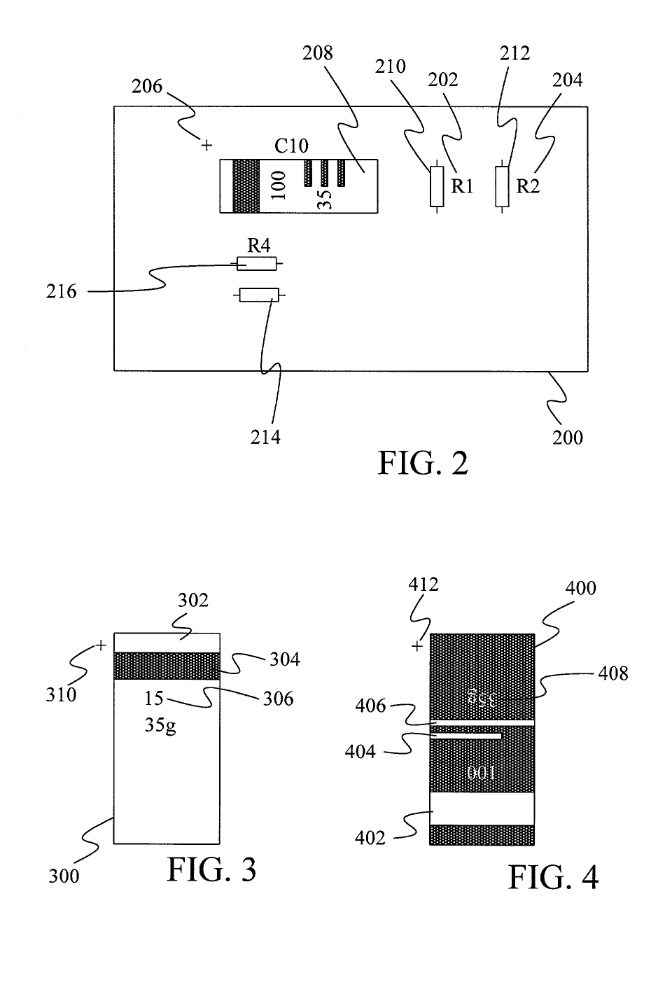

FIG. 2 is a top view of a printed circuit board 200 showing components and markings on the printed circuit board. In particular, printed circuit board 200 includes markings 202, 204 and 206 that indicate the position of two resistors and the orientation of a capacitor, respectively. In particular, marking 206 indicates where the positive polarity lead/terminal of a capacitor 208 should be located on printed circuit board 200. Printed circuit board 200 also includes other components such as components 210, 212, 214 and 216.

Tantalum capacitors, such as capacitor 208, come in different colored packages depending on the manufacturer. Two such packages are shown in FIGS. 3 and 4. Capacitor 300 of FIG. 3 includes an outer package 302 that is yellow with brown markings. Thus, on the package of capacitor 300, markings such as polarity band 304 and writing 306 are brown while the remainder of outer package 302 is yellow.

Capacitor 400 of FIG. 4 shows a tantalum capacitor produced by a different supplier. Capacitor 400 includes different coloring and markings. In particular, the outer package of capacitor 400 is largely black with silver-white markings. Thus, polarity band marking 402, decorative bands 404 and 406 and text 408 are all silver-white while the remainder of the package is black.

In FIG. 3, tantalum capacitor 300 is shown installed with the proper orientation in the printed circuit board such that polarity band 304 is near polarity marking 310 on the printed circuit board. However, tantalum capacitor 400 of FIG. 4 is shown installed with an improper orientation because polarity band 402 is shown opposite polarity marking 412 on the printed circuit board.

Embodiments of the present invention provide an apparatus and associated method for identifying whether a capacitor has been properly installed as shown in FIG. 3 or whether it has been oriented improperly as shown in FIG. 4. In addition, embodiments of the present invention do not rely on templates, but instead can adapt to changes in the package configuration and in particular to the coloring of the capacitors used in the printed circuit board.

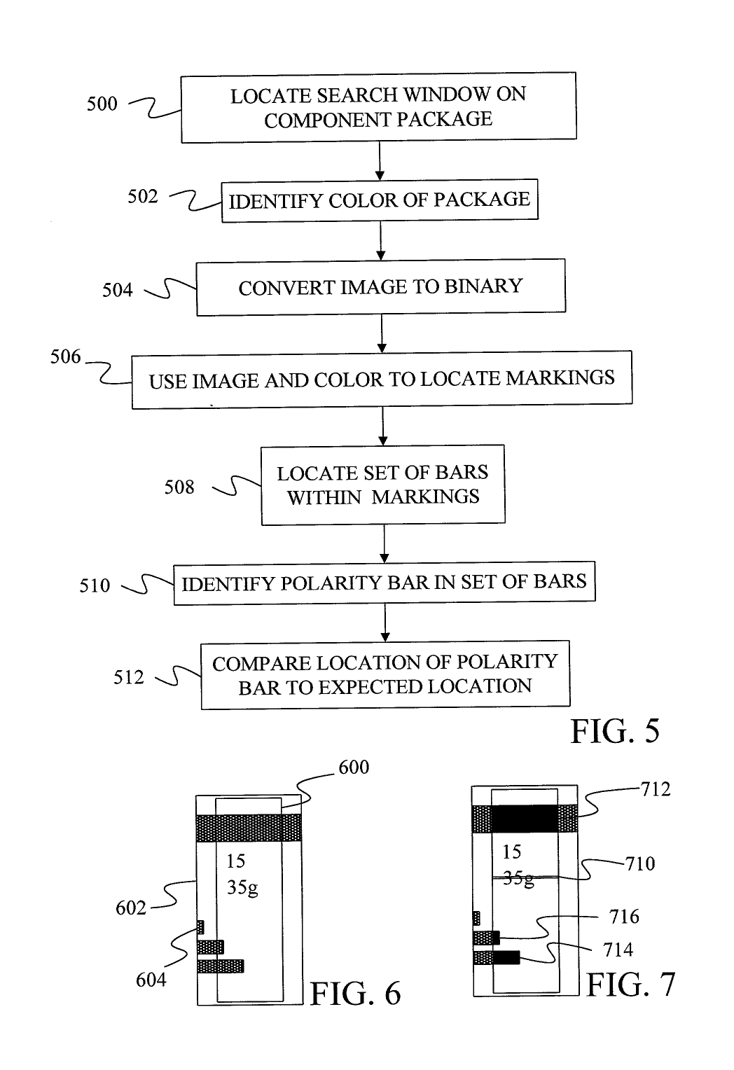

One method for detecting the orientation of capacitors under the present invention is shown in the flow diagram of FIG. 5. This method begins at step 500 where a search window is located on the component package to define an area that will be optically inspected to determine the orientation of the capacitor. An example of a search window 600 is shown in FIG. 6 relative to a capacitor 602. In the embodiment of FIG. 6, search window 600 extends over the full length of capacitor 602 but has a reduced width. By defining the search window in this manner, visual noise present in markings located on the edges of capacitor 602 is filtered out. For example, marking 604 is not found within search window 600, and is thus filtered from consideration during the optical inspection. The step of locating the search window involves locating the capacitor on the printed circuit board using a rough template, identifying the boundaries of the capacitor based on edges in the optical image of the full printed circuit board, and then placing the search area over the capacitor such that it is centered on the capacitor.

Once the search window has been located at step 500, the color of the package is identified at step 502. The package color is identified under one embodiment of the present invention using a red-green-blue plane. Such a plane has separate sets of optical receptors for red light, green light and blue light. The mean intensity from the red, green and blue receptors are then compared to identify the relative color of the capacitor package. For example, if the possible colors for the capacitor packages are yellow and black, a simple decision can be made as to whether the capacitor is yellow or black by subtracting the mean of the intensity measured by the blue receptors from the mean of the intensity measured by the red receptors and comparing the difference to a color detect threshold. Since yellow tends to have more red in it than black does, and black tends to have more blue than yellow does, if the difference between the red intensity and blue intensity is above the threshold, the package color is yellow. However, if the difference is below the color detect threshold, the color is black.

Note that the example above is but one example for the colored packages. The package color detect threshold can change depending on the color of the packages that are trying to be distinguished from each other. In addition, the package color detect threshold may be varied to improve the performance of the optical inspection system so that it better detects the actual color of the package.

After the color of the package has been identified, the image in the search window is converted into a binary image of two classes: “dark” and “bright.” An example of this binary image is shown in FIG. 7.

At step 506 the binary image and the identified color are used to locate markings within the search window. If the package color is a dark color, the markings are identified as bright areas in the binary image of the search window. However, if the package is a light color, the markings are designated by dark areas in the binary image.

At each location where markings have been identified in the search window, an attempt is made to identify whether the markings are a band that crosses the entire search window or some other marking. This is shown as step 508 in FIG. 5. To determine whether a marking is a band, columns of pixels that pass through the markings, such as column 710 of FIG. 7, are examined. In particular, the number of pixels in a column that contain the same binary class associated with the markings (i.e. bright for a dark colored package or dark for a light colored package) are counted. If the number of pixels exceeds a band search threshold the column is marked as belonging to a band. If the number of pixels is less than the band search threshold, the column is identified as belonging to a character marking.

Not every band located in step 508 is a polarity bar. Because of this, the polarity bar must be identified from the set of bars located in step 508. For example, bars 712, 714 and 716 would be identified in step 508, but only bar 712 is a polarity bar.

Under one embodiment, the polarity bar is identified from the set of bars at step 510 by measuring the thickness, or number of contiguous pixel columns, that are marked as band columns. The thickest bar identified is then chosen as the polarity bar. At step 512, the location of the polarity bar relative to the printed circuit board is then compared to an expected location to determine if the capacitor has been placed properly on the printed circuit board.

Note that the method of FIG. 5 does not require the use of templates. As such, components may be changed and the optical identification system will still operate.

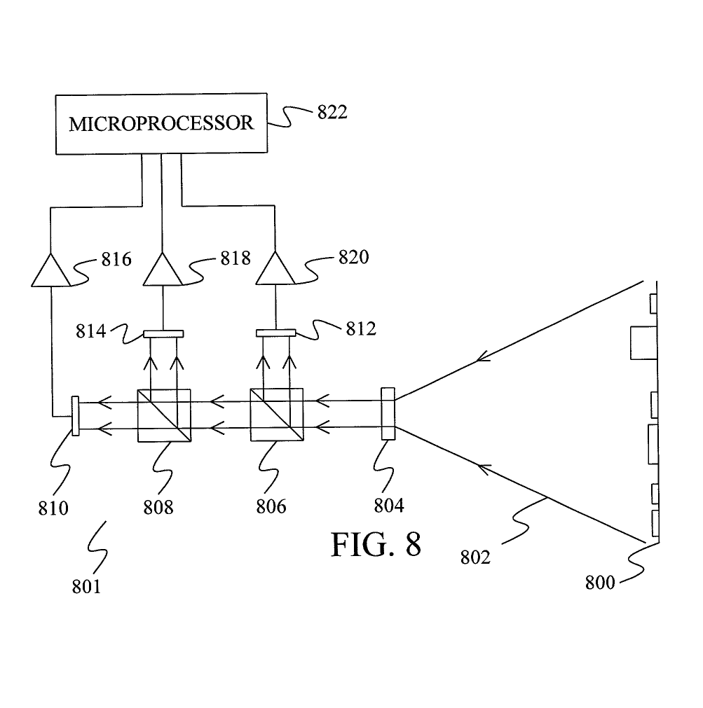

FIG. 8 provides a block diagram of an optical inspection system 801 in accordance with an embodiment of the present invention. In FIG. 8, a printed circuit board 800 reflects a light beam 802 toward a lens 804. Lens 804 directs the lightbeam through a series of light splitters 806 and 808. Light splitters 806 and 808 reflect a portion of the light that is incident on the splitters toward detector planes 812 and 814. Some of the light incident on splitters 806 and 808 passes through splitter 808 to detector 810. In one embodiment, detector plan 810 detects red wavelengths of light, detector 812 detects green wavelengths of light, and detector 814 detects blue wavelengths of light. The signals from the detectors on detector planes 810, 812 and 814 are amplified by a set of amplifiers 816, 818 and 820 to produce a set of color signals that are provided to a microprocessor 822.

Microprocessor 822 then performs the functions listed in the flow diagram of FIG. 5. In this capacity, microprocessor 822 is configured by instructions to operate as a color determination component that determines the color of the package, a search window locating component that defines a search area on an image of the package, a binary imaging component that converts an image of a package into a binary image having dark and light areas, a markings component that identifies the location of markings based on the binary image, a bar locating component that locates bars in the markings location, and a polarity bar locating component that identifies a polarity bar in the markings location.

Although FIG. 8 shows a single conductor being output from detector planes 810, 812 and 814, those skilled in the art will recognize that a plurality of conductors may be connected to each detector plane such that there is a single conductor for each detector on each detector plane.

In summary, an apparatus and associated method of inspecting a printed circuit board 200, 800 identifies a color for a package of a component 300, 400 and dark areas 712, 714, 716 and light areas on the component 300, 400. The identified color is then used to determine which of the dark areas 712, 714, 716 or light areas represent markings 306, 304, 402, 408. From the identified markings, the orientation of the component is determined.

An optical inspection system 801 is also provided that includes a first light detector 810 and a second light detector 812, which provide first and second detection signals, respectively. A color determination component 822 determines a color for a package 300, 400 on a printed circuit board 200 based on the first and second detection signals. A markings component 822 identifies the location of markings 304, 306, 402, 404, 406, 408 based in part on the color of the package 300, 400. An orientation marking identification component 822 then identifies an orientation marking in the location of the markings identified by the markings component 822.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the optical inspection system while maintaining substantially the same functionality without departing from the scope and spirit of the present invention. In addition, although the preferred embodiment described herein is directed to an optical inspection system for inspecting printed circuit boards in a disc drive system, it will be appreciated by those skilled in the art that the teachings of the present invention can be applied to inspecting printed circuit boards in any type of electrical system, without departing from the scope and spirit of the present invention.

What is claimed is:

1. A method of inspecting a printed circuit board having components inserted therein, the method comprising steps of:
(a) identifying a color for a package of a component;
(b) identifying dark areas and light areas on the package;
(c) using the identified color to determine which of the dark areas or the light areas represent markings; and
(d) using the markings to determine the orientation of the component on the printed circuit board.

2. The method of claim 1 wherein identifying a color for the package comprises identifying a color for a majority of the package.

3. The method of claim 2 wherein identifying a color comprises determining an average intensities for at least two colors of light from the package.

4. The method of claim 3 wherein identifying a color further comprises subtracting the average intensity of one color of light from the average intensity of a second color of light and comparing the difference to a threshold value to identify a color for the package.

5. The method of claim 3 wherein determining an average intensity for at least two colors of light comprises determining an average intensity of red, green and blue wavelengths of light.

6. The method of claim 1 wherein identifying dark areas and light areas on the package comprises generating a binary representation of an optical image of at least a portion of the component.

7. The method of claim 1 wherein using the markings to determine the orientation of the component comprises identifying at least one orientation marking on the package.

8. The method of claim 7 wherein identifying at least one orientation marking on the package comprises identifying at least one bar on the package.

9. The method of claim 8 wherein identifying at least one bar comprises identifying a set of bars.

10. The method of claim 9 wherein identifying at least one orientation marking further comprises identifying an orientation bar within the set of bars.

11. The method of claim 10 wherein identifying an orientation bar comprises determining the relative thickness of each bar in the set of bars and selecting the thickest bar as the orientation bar.

12. The method of claim 1 wherein the markings of step (c) are associated with an electrical polarity of the component.

13. An optical inspection system for inspecting a printed circuit board, the optical inspection system comprising:
a first light detector for generating a first detection signal based on a first color of light reflected from the printed circuit board;
a second light detector for generating a second detection signal based on a second color of light reflected from the printed circuit board;
a color determination component that determines a color for a package on the printed circuit board based on the first and second detection signals;
a markings component that identifies the location of markings on the package based in part on the color of the package; and
an orientation marking identification component that identifies an orientation marking in the location of the markings identified by the markings component.

14. The optical inspection system of claim 13 wherein the color determination component determines the color for the package by subtracting the first detection signal from the second detection signal.

15. The optical inspection system of claim 13 further comprising a binary image component that generates a binary image of at least a portion of a package based on at least one detection signal from a light detector and wherein the markings component identifies the location of markings based in part on the binary image.

16. The optical inspection system of 13 wherein the orientation marking identification component comprises a bar identification component that identifies at least one bar in the location of the markings.

17. The optical system of claim 16 wherein the orientation marking identification component further comprises a polarity bar identification component that identifies a polarity bar from the at least one bar identified by the bar identification component.

18. The optical system of claim 17 wherein the polarity bar identification component identifies the polarity bar by comparing the thickness of at least two bars identified by the bar identification component.

19. An optical inspection system for inspecting a printed circuit board having components, the optical inspection system comprising:
at least one lens and light detector that collect and detect light reflected from the printed circuit board; and
orientation identification means for identifying the orientation of a component by determining the color of the component and by using a binary image of the component and the color of the component to determine the location of a polarity bar on the component.

20. The optical inspection system of claim 19 wherein the at least one detector comprises a first detector and a second detector and wherein the orientation identification means uses a first detection signal from the first detector and a second detection signal from the second detector to determine the color of the component.

21. The optical inspection system of claim 19 wherein the orientation means determines the location of a polarity bar by identifying a set of bars on the package and determining which of the bars in the set of bars is the polarity bar.
